(19) United States
(12) Patent Application Publication
(10) Pub. No.: US 2009/0321383 A1
(43) Pub. Date: Dec. 31, 2009

(54) Single serve container

(76) Inventor: Michael T. Lane, Brooklyn, MI (US)

Correspondence Address: HARNESS, DICKEY & PIERCE, P.L.C., P.O. BOX 828, BLOOMFIELD HILLS, MI, 48303, US

(21) Appl. No.: 12/215,885

(22) Filed: Jun. 30, 2008

(51) Int. Cl. B65D 8/04; B65B 7/28; B29D 22/00

(52) U.S. Cl. 215/382; 215/44; 264/572

(57) ABSTRACT

A one-piece plastic container includes a body that defines a longitudinal axis and has an upper portion, a sidewall portion, and a base portion. The upper portion defines an opening into the container. The sidewall portion is integrally formed with and extends from the upper portion to the base portion. The base portion closes off an end of the container. The one-piece plastic container is formed from resin having an intrinsic viscosity (IV) of about 0.73 or less.

### TECHNICAL FIELD

This disclosure generally relates to plastic containers for retaining a commodity, such as a solid or liquid commodity. More specifically, this disclosure relates to a single serve, one-piece blown container formed with resin having a low intrinsic viscosity (IV).

### BACKGROUND

As a result of environmental and other concerns, plastic containers, more specifically polyester and even more specifically polyethylene terephthalate (PET) containers are now being used more than ever to package numerous commodities previously supplied in glass containers. Manufacturers and fillers, as well as consumers, have recognized that PET containers are lightweight, inexpensive, recyclable and manufacturable in large quantities.

Blow-molded plastic containers have become commonplace in packaging numerous commodities. PET is a crystallizable polymer, meaning that it is available in an amorphous form or a semi-crystalline form. The ability of a PET container to maintain its material integrity relates to the percentage of the PET container in crystalline form, also known as the “crystallinity” of the PET container. The following equation defines the percentage of crystallinity as a volume fraction:

$$\% Crystallinity = ( \frac{ρ - {ρ}_{a}}{{ρ}_{c} - {ρ}_{a}} ) \times 100$$

where ρ is the density of the PET material; ρₐ is the density of pure amorphous PET material (1.333 g/cc); and ρ_{c} is the density of pure crystalline material (1.455 g/cc).

Container manufacturers use mechanical processing and thermal processing to increase the PET polymer crystallinity of a container. Mechanical processing involves orienting the amorphous material to achieve strain hardening. This processing commonly involves stretching an injection molded PET preform along a longitudinal axis and expanding the PET preform along a transverse or radial axis to form a PET container. The combination promotes what manufacturers define as biaxial orientation of the molecular structure in the container. Manufacturers of PET containers currently use mechanical processing to produce PET containers having approximately 20% crystallinity in the container's sidewall.

Thermal processing involves heating the material (either amorphous or semi-crystalline) to promote crystal growth. On amorphous material, thermal processing of PET material results in a spherulitic morphology that interferes with the transmission of light. In other words, the resulting crystalline material is opaque, and thus, generally undesirable. Used after mechanical processing, however, thermal processing results in higher crystallinity and excellent clarity for those portions of the container having biaxial molecular orientation. The thermal processing of an oriented PET container, which is known as heat setting, typically includes blow molding a PET preform against a mold heated to a temperature of approximately 250° F.-350° F. (approximately 121° C.-177° C.), and holding the blown container against the heated mold for approximately two (2) to five (5) seconds. Manufacturers of PET juice bottles, which must be hot-filled at approximately 185° F. (85° C.), currently use heat setting to produce PET bottles having an overall crystallinity in the range of approximately 25% -35%.

As is typical for PET manufacturing, a resin having an IV of 0.80 is used for blow-molding containers. An IV of 0.80 has been used to accommodate larger container sizes, heavier container weights and higher blow process temperatures. In some examples, resins having an IV of 0.76 have been used in forming smaller containers (i.e., such as single serve water bottles for example) because of lighter container weights and lower blow process temperatures.

As can be appreciated, a number of factors contribute to the overall cost in manufacturing such PET containers. Among these factors can include air cooling time required on an inside surface of the container prior to removing it from a mold, an amount of heat required to melt the resin, the pressure required during the injection molding sequence, and other factors.

### SUMMARY

A one-piece plastic container includes a body that defines a longitudinal axis and has an upper portion, a sidewall portion, and a base portion. The upper portion defines an opening into the container. The sidewall portion is integrally formed with and extends from the upper portion to the base portion. The base portion closes off an end of the container. The one-piece plastic container is formed from resin having an intrinsic viscosity (IV) of 0.73 or less.

According to additional features, the resin can have an IV of between about 0.73 and about 0.58. The one-piece plastic container is a single serve container that can be substantially about 20 fluid ounces or less.

A method of making a blow-molded plastic container includes disposing a preform into a mold cavity, the preform comprising a resin having an intrinsic viscosity (IV) of 0.73 or less. The preform is blown against a mold surface of the mold cavity to form an upper portion, a sidewall portion, and a base portion. The sidewall portion is integrally formed with and extends between the upper portion and the base portion. The base portion closes off an end of the container.

Additional benefits and advantages of the present disclosure will become apparent to those skilled in the art to which the present disclosure relates from the subsequent description and the appended claims, taken in conjunction with the accompanying drawings.

### BRIEF DESCRIPTION OF THE DRAWINGS

FIG. 1 is a side elevational view of a one-piece plastic container constructed in accordance with the teachings of the present disclosure.

FIG. 2 is a sectional view of an exemplary mold cavity used during formation of the container of FIG. 1 and shown with a preform positioned therein.

FIG. 3 is a sectional view of the exemplary mold cavity of FIG. 2 and shown after a blow-molding process.

FIG. 4 is a sectional view of another exemplary mold cavity used during formation of the container of FIG. 1 according to additional features and shown with an exemplary preform positioned therein; and

FIG. 5 is a side elevational view of an intermediate container formed by the mold cavity of FIG. 4.

### DETAILED DESCRIPTION

The following description is merely exemplary in nature, and is in no way intended to limit the disclosure or its application or uses.

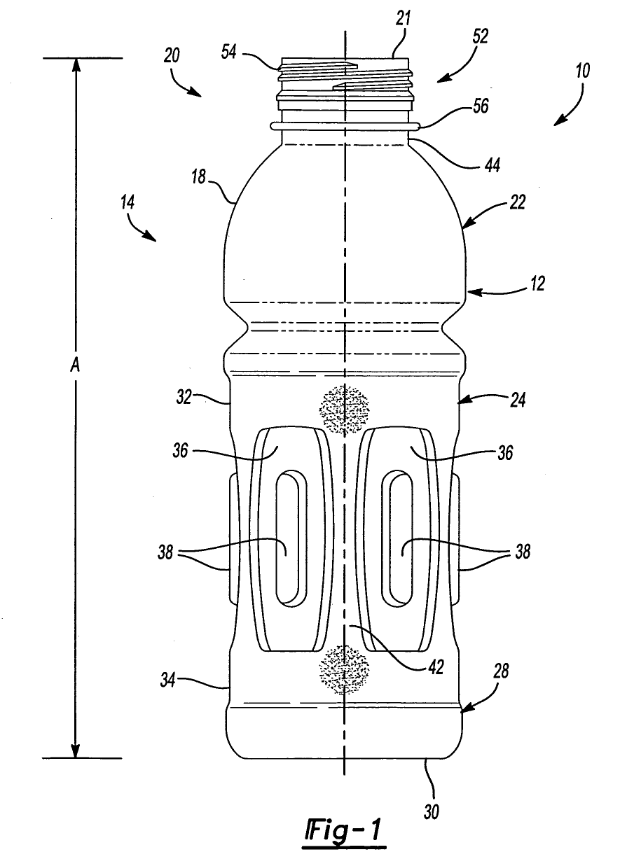

FIGS. 1-4 show one preferred embodiment of the present container. In the Figures, reference number 10 designates a one-piece plastic, e.g. polyethylene terephthalate (PET), hot-fillable container. As shown in FIG. 1, the container 10 has an overall height A of about 189 mm (7.45 inches). As shown in the Figures, the container 10 is substantially cylindrical in cross section. In this particular embodiment, the container 10 is a single serve container having a volume capacity of about 20 fl. oz. (591 ml). Those of ordinary skill in the art would appreciate that the following teachings of the present invention are applicable to other containers, such as rectangular, triangular, hexagonal, octagonal or square shaped containers, which may have different dimensions and volume capacities. It is also contemplated that other modifications can be made depending on the specific application and environmental requirements.

As will become appreciated from the following discussion, the present teachings provide a single serve container (such as a container having 20 fluid ounces or less) that is formed from resin having a low intrinsic viscosity (IV). As used herein, “low IV” defines a resin having an IV of approximately 0.73 or less. More specifically, the present disclosure is directed toward forming a container with a resin having an IV of substantially about 0.58 to about 0.73. By using low IV resin, various factors contributing to the overall cost in manufacturing a single serve PET container can be improved, such as, but not limited to, air coolant time required on an inside surface of the container prior to removing it from a mold, an amount of heat required to melt the resin, and a pressure required during the injection molding sequence.

As shown in FIGS. 1-4, the one-piece plastic container 10 according to the present teachings defines a body 12 and includes an upper portion 14 having a cylindrical sidewall 18 forming a finish 20. The finish 20 defines an opening 21 into the plastic container 10. Integrally formed with the finish 20 and extending downward therefrom is a shoulder region 22. The shoulder region 22 merges into and provides a transition between the finish 20 and a sidewall portion 24. The sidewall portion 24 extends downward from the shoulder region 22 to a base portion 28 having a base 30. The body 12 features an upper label panel edge or indent 32, a lower label panel edge or indent 34 and a plurality of vacuum panels 36. The vacuum panels 36 illustrated in FIG. 1 are of typical, generally recessed configuration featuring standing island 38 geometry. Those skilled in the art are aware of several alternative vacuum panel configurations which are common, including vacuum panels having ribs, logo embossments, and other similar geometric features. Between any pair of adjacent vacuum panels 36 is a land area 42.

The exemplary container 10 may also have a neck 44. The neck 44 may have an extremely short height, that is, becoming a short extension from the finish 20, or an elongated height, extending between the finish 20 and the shoulder region 22. The plastic container 10 has been designed to retain a commodity. The commodity may be in any form such as a solid or liquid product. In one example, a liquid commodity may be introduced into the container during a thermal process, typically a hot-fill process. For hot-fill bottling applications, bottlers generally fill the container 10 with a liquid or product at an elevated temperature between approximately 155° F. to 205° F. (approximately 68° C. to 96° C.) and seal the container 10 with a closure (not illustrated) before cooling. In addition, the plastic container 10 may be suitable for other high-temperature pasteurization or retort filling processes or other thermal processes as well. In another example, the commodity may be introduced into the container under ambient temperatures.

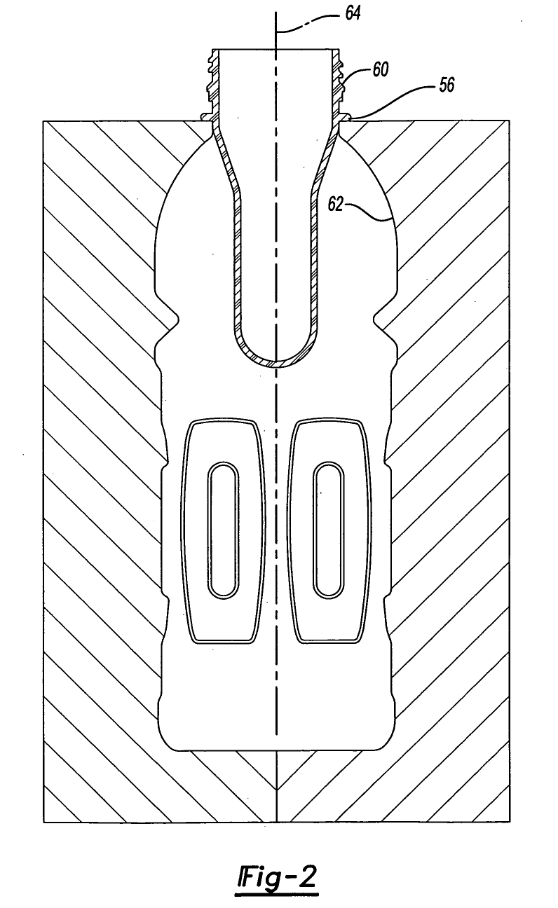

The finish 20 of the plastic container 10 may include a threaded region 52 having threads 54, and a support ring 56. The threaded region 52 provides a means for attachment of a similarly threaded closure or cap (not illustrated). Alternatives may include other suitable devices that engage the finish 20 of the plastic container 10 such as a press-fit or snap-fit cap for example. Accordingly, the closure or cap (not illustrated) engages the finish 20 to preferably provide a hermetical seal of the plastic container 10. The closure or cap (not illustrated) is preferably of a plastic or metal material conventional to the closure industry and suitable for subsequent thermal processing, including high temperature pasteurization and retort. The support ring 56 may be used to carry or orient a preform 60 (FIG. 2) through and at various stages of manufacture. For example, the preform 60 may be carried by the support ring 56, the support ring 56 may be used to aid in positioning the preform 60 in the mold, or an end consumer may use the support ring 56 to carry the plastic container 10 once manufactured.

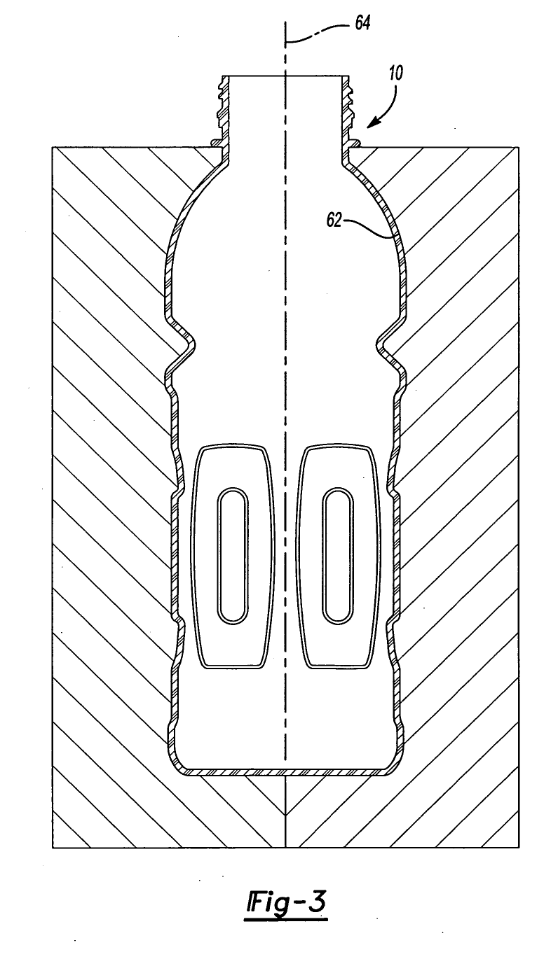

Turning now to FIGS. 2 and 3, the preform 60 used to mold an exemplary container having the finish 20 will be described. The plastic container of the present teachings is a blow molded, biaxially oriented container with a unitary construction from a single or multi-layer material. A well-known stretch-molding, heat-setting process for making hot-fillable plastic containers generally involves the manufacture of the preform 60 through injection molding of a polyester material, such as polyethylene terephthalate (PET), having a shape well known to those skilled in the art similar to a test-tube with a generally cylindrical cross section and a length typically approximately fifty percent (50%) that of the resultant container height. A machine (not illustrated) places the preform 60 heated to a temperature between approximately 190° F. to 250° F. (approximately 88° C. to 121° C.) into a mold cavity 62 having a shape similar to the resultant plastic container.

The mold cavity 62 may be heated to a temperature between approximately 250° F. to 350° F. (approximately 121° C. to 177° C.). A stretch rod apparatus (not illustrated) stretches or extends the heated preform 60 within the mold cavity 62 to a length approximately that of the resultant container thereby molecularly orienting the polyester material in an axial direction generally corresponding with a central longitudinal axis 64 of the resultant container 10. While the stretch rod extends the preform 60, air having a pressure between 300 PSI to 600 PSI (2.07 MPa to 4.14 MPa) assists in extending the preform 60 in the axial direction and in expanding the preform 60 in a circumferential or hoop direction thereby substantially conforming the polyester material to the shape of the mold cavity 62 and further molecularly orienting the polyester material in a direction generally perpendicular to the axial direction, thus establishing the biaxial molecular orientation of the polyester material in most of the container. Typically, material within the finish 20 and the base portion 28 are not substantially molecularly oriented. The pressurized air holds the mostly biaxial molecularly oriented polyester material against the mold cavity 62 for a period of approximately two (2) to five (5) seconds before removal of the container from the mold cavity.

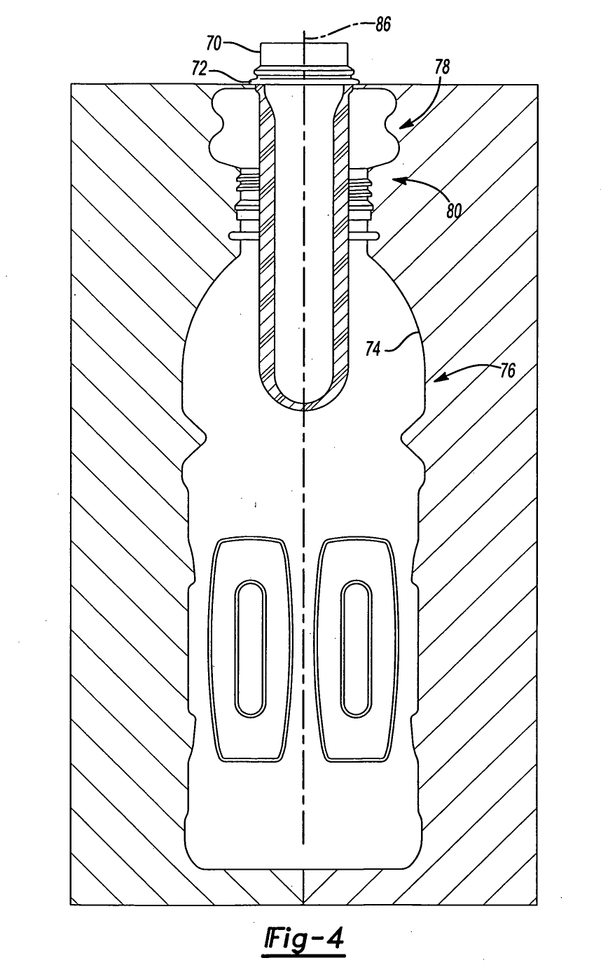

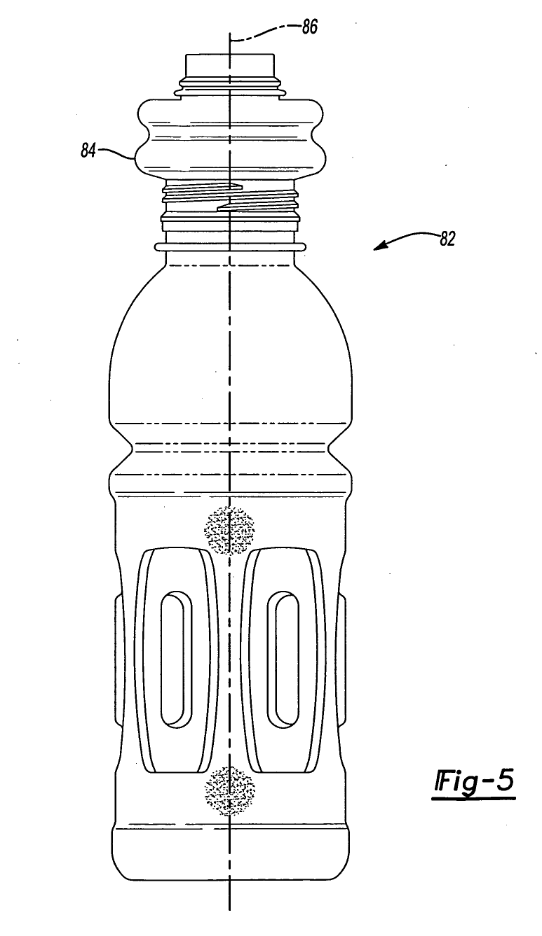

With reference now to FIGS. 4 and 5, an exemplary method of forming the container 10 according to additional features will be described. A preform 70 may define a rim 72. At the outset, the preform 70 may be placed into a mold cavity 74 such that the rim 72 is captured at an upper end of the mold cavity 74. In general, the mold cavity 74 has an interior surface corresponding to a desired outer profile of the blown container. More specifically, the mold cavity 74 according to the present teachings defines a body forming region 76, a moil forming region 78 and an opening forming region 80. Once the resultant structure, hereinafter referred to as an intermediate container 82 (FIG. 5), has been formed, a moil 84 (FIG. 5) created by the moil forming region 78 may be severed and discarded. It is appreciated that the step of severing the moil 84, defines the opening (i.e., feature 21, FIG. 1) of the container 10 at the finish 20.

In one example, a machine (not illustrated) places the preform 70 heated to a temperature between approximately 190° F. to 250° F. (approximately 88° C. to 121° C.) into the mold cavity 74. The mold cavity 74 may be heated to a temperature between approximately 250° F. to 350° F. (approximately 121° C. to 177° C.). A stretch rod apparatus (not illustrated) stretches or extends the heated preform 70 within the mold cavity 74 to a length approximately that of the intermediate container 82 thereby molecularly orienting the polyester material in an axial direction generally corresponding with the central longitudinal axis 86 of the intermediate container 82 or of the resultant container 10 (i.e., FIG. 1). While the stretch rod extends the preform 70, air having a pressure between 300 PSI to 600 PSI (2.07 MPa to 4.14 MPa) assists in extending the preform 70 in the axial direction and in expanding the preform 70 in a circumferential or hoop direction thereby substantially conforming the polyester material to the shape of the mold cavity 74 and further molecularly orienting the polyester material in a direction generally perpendicular to the axial direction, thus establishing the biaxial molecular orientation of the polyester material in most of the intermediate container 82. The pressurized air holds the mostly biaxial molecularly oriented polyester material against the mold cavity 74 for a period of approximately two (2) to five (5) seconds before removal of the intermediate container 82 from the mold cavity 74.

Alternatively, other manufacturing methods using other conventional materials including, for example, polypropylene, high-density polyethylene, polyethylene naphthalate (PEN), a PET/PEN blend or copolymer, and various multilayer structures may be suitable for the manufacture of the plastic container 10. Those having ordinary skill in the art will readily know and understand plastic container manufacturing method alternatives.

In each of the Tables 1-4, comparisons between forming a container using a low IV resin (0.73 IV in this example) and a typical resin (0.80 IV) are illustrated. As used herein, the term “Benchmark” is used to denote a container having a resin of 0.80 IV. With reference to Table 1, formation of a container (i.e., container 10) using low IV resin can be accomplished using reduced air cooling time and reduced injection pressures while still maintaining product volume and weight requirements. As can be appreciated, reduced air cooling and injection pressure requirements of a low IV container result in a manufacturing cost savings over a container having 0.80 IV resin.

TABLE 1

| | (CONTAINER 10) | (Benchmark) |
|---|---|---|
| Resin Variable | 0.73 IV | 0.80 IV |
| Container thermal stability | (−1.4 ml) | (−1.0 ml) |
| Container sidewall crystalinity | 26% | 27% |
| Blow molding rate | 19,600 bph | 19,600 bph |
| Air cooling time | 0.18 sec | 0.20 sec |
| Injection cycle time | 17.6 sec | 17.6 sec |
| Injection pressures | 1076 psi | 1213 psi |
| *Percent Air Cooling Reduction | (−10%) | |
| from Control (Container) | | |
| *Percent Pressure Reduction | (−11%) | |
| from Control (Preform) | | |

*cycle reduction may be an alternative means to meet volume & targets.

Table 2 illustrates a reduction in required injection pressure for the low IV resin as compared to the 0.80 IV resin. A pressure requirement reduction of about 11% over the Benchmark is realized.

TABLE 2

| | | (CONTAINER 10) | (Benchmark) |
|---|---|---|---|
| Resin Variable | | 0.73 IV | 0.80 IV |
| Part Weight (g) | | 37.71 | 37.66 |
| Mold Temperature (° F.) | | 540 | 540 |
| Temperatures (° F.) | Feed | 540 | 540 |
| | Zone 1 | 540 | 540 |
| | Zone 2 | 541 | 541 |
| | Zone 3 | 542 | 542 |
| | Zone 4 | 541 | 541 |
| Injection Pressure (psi) | | 1076 | 1216 |
| Injection Time (s) | | 4.28 | 4.28 |
| Injection Flow rates (mm/s) | | 40/60/65 | 40/60/65 |
| Transition point (mm) | | 35 | 35 |
| Holding Pressures (bar) | 1 | 675 | 675 |
| | 2 | 510 | 510 |
| Hold Times (s) | 1 | 4.00 | 4.00 |
| | 2 | 2.00 | 2.00 |
| Cooling Time (s) | | 2.0 | 2.0 |
| Total Cycle Time (s) | | 17.6 | 17.6 |
| Screw Speed (rpm) | | 63 | 63 |
| Back Pressure (psi) | | 200 | 200 |
| Shot Size (mm) | | 245 | 245 |
| Inj Time (s) | | 4.28 | 4.28 |
| Cushion (mm) | | 7.4 | 7.5 |
| Resin Moisture (ppm) | | 0.00 | 0.00 |
| check | | | |

Table 3 illustrates a free blow evaluation for the two resin variables. As shown, at 60° C., where the free blow evaluation was conducted, the differences between the natural stretch ratios of the materials are relatively small. The 0.80 IV resin has a higher areal strain as compared to the low IV resin. Furthermore, section weight sigma values from the evaluation were also similar, indicating a minimal overall process effect.

TABLE 3

| | Preform | Blow | Balloon | | | |
|---|---|---|---|---|---|---|
| | Temperature | Pressure | Volume | Axial | Radial | Areal |
| Resin | (° C.) | (psi) | (ml) | Strain | Strain | Strain |
| (Benchmark) | 60 | 100 | 1598 | 2.9 | 2.9 | 11.4 |
| 0.80 IV | | | 1-sigma (29.8) | | | |
| (CONTAINER 10) | 60 | 100 | 1448 | 2.9 | 2.9 | 11.0 |
| 0.73 IV | | | 1-sigma (25.2) | | | |

Table 4 illustrates a summary of the blow-molding processes for each of the resins. As shown, section weight and dimensional data indicates reasonable consistency between the low IV container and the 0.80 IV container. Additionally, the mean and sigma values for both containers are similar when operating conditions are optimized for each resin.

TABLE 4

| | | (CONTAINER 10) | (Benchmark) |
|---|---|---|---|
| Resin Variable | | 0.73 IV | 0.80 IV |
| Blow Molder Settings | Machine Speed (BPH) | 19,600 | 19,600 |
| | Overall Power (%) | 80 | 80 |
| | Mold Temp (° F.) | 275 | 275 |
| Preform Temperature (° C.) | | 99.2 | 99.0 |
| Section Weights (g) | Shoulder (15.6 gm) | 15.6 | 15.8 |
| | Waist (3.8 gm) | 3.7 | 3.7 |
| | Upper Panel (6.0 gm) | 6.1 | 5.9 |
| | Lower Panel (6.0 gm) | 5.9 | 5.9 |
| | Base (6.5 gm) | 6.4 | 6.5 |
| Dimensions/Volume/Topload | Height (7.634 in) | 7.639 | 7.625 |
| | Overflow Volume (627 ml) | 629 | 629 |
| | HF Volume Shrinkage | (1.4) | (1.0) |
| | Topload (65 lbs) | 64 | 66 |
| Blow Timing/Pressures | Pre Blow Cam (°) | 0.06 | 0.06 |
| | High Air Cam (°) | 1.16 | 1.16 |
| Lamp Settings | *Zone 7 (%) | 30 | 28 |
| | *Zone 6 (%) | 30 | 22 |
| | Zone 5 (%) | 75 | 75 |
| | Zone 4 (%) | 95 | 95 |
| | Zone 3 (%) | 90 | 90 |
| | *Zone 2 (%) | 49 | 56 |
| | *Zone 1 (%) | 78 | 83 |

As can be appreciated from the above teachings, resin “stiffness” (i.e., intrinsic viscosity) is less critical for a single serve container (less than or equal to 20 fluid ounces). A single serve container is typically less than 3 inches (76.2 mm) in diameter, such that the radial stiffness is essentially controlled by container design. In addition, a diameter of a finish (i.e., feature 20, FIG. 1) of a single serve container is typically less than 1.5 inches (38 mm), which minimizes finish cycle constraint. Also, preform lengths are typically less than 3.5 inches (88.9 mm) for single serve containers. Material distribution is essentially set by preform design since the blow process is typically limited to a three lamp oven profile.

While the above description constitutes the present disclosure, it will be appreciated that the disclosure is susceptible to modification, variation and change without departing from the proper scope and fair meaning of the accompanying claims.

What is claimed is:

1. A one-piece plastic container comprising:
a body defining a longitudinal axis and having an upper portion, a sidewall portion and a base portion, said upper portion defining an opening into said container, said sidewall portion integrally formed with and extending from said upper portion to said base portion, said base portion closing off an end of said container, wherein said one-piece plastic container is formed from resin having an intrinsic viscosity (IV) of about 0.73 or less.

2. The one-piece plastic container of claim 1 wherein said IV is between about 0.73 and about 0.58.

3. The one-piece plastic container of claim 2 wherein said one-piece plastic container is a single serve container.

4. The one-piece plastic container of claim 3 wherein said one-piece plastic container is substantially about 20 fluid ounces.

5. The one-piece plastic container of claim 3 wherein said one-piece plastic container is substantially less than about 20 fluid ounces.

6. The one-piece plastic container of claim 2 wherein said IV is substantially about 0.58.

7. The one-piece plastic container of claim 1 wherein said one-piece plastic container is heat set.

8. The one-piece plastic container of claim 1 wherein said one-piece plastic container has an overall crystallinity in a range of approximately 25% to approximately 35%.

9. The one-piece plastic container of claim 2 wherein said upper portion defines a finish and said finish defines a generally cylindrical sidewall having at least one thread thereon.

10. The one-piece plastic container of claim 9 wherein said body is generally cylindrical from said upper portion to said base portion.

11. A method of making a blow-molded plastic container comprising:
disposing a preform into a mold cavity, the preform comprising a resin having an intrinsic viscosity (IV) of about 0.73 or less; and
blowing said preform against a mold surface of said mold cavity to form an upper portion, a sidewall portion and a base portion, said sidewall portion integrally formed with and extending between said upper portion and said base portion, said base portion closing off an end of the container.

12. The method of claim 11 wherein blowing said preform includes forming a single serve blow-molded plastic container.

13. The method of claim 12 wherein blowing said preform includes forming a single serve blow-molded plastic container that is substantially about 20 fluid ounces.

14. The method of claim 12 wherein blowing said preform includes forming a single serve blow-molded plastic container that is substantially less than about 20 fluid ounces.

15. The method of claim 11 wherein blowing said preform includes a heat setting process.

16. The method of claim 11 wherein blowing said preform includes forming a single serve blow-molded plastic container having an overall crystallinity in a range of approximately 25% to approximately 35%.

17. The method of claim 11 wherein disposing said preform comprises disposing a preform having an intrinsic viscosity (IV) of between about 0.73 and about 0.58.

18. The method of claim 17 wherein disposing said preform comprises disposing a preform having an intrinsic viscosity (IV) substantially about 0.58.
